(19) United States
(12) Patent Application Publication
(10) Pub. No.: US 2018/0073468 A1
(43) Pub. Date: Mar. 15, 2018

(54) PNEUMATIC HYBRID I.C. ENGINE HAVING WATER INJECTION

(71) Applicant: John Parley Wilson, Columbus, IN (US)

(72) Inventor: John Parley Wilson, Columbus, IN (US)

(21) Appl. No.: 15/264,318

(22) Filed: Sep. 13, 2016

(51) Int. Cl. F02M 25/022; F02M 25/03; F02M 25/028; F02M 23/12; F01N 3/10; F02M 26/35

(52) U.S. Cl. CPC F02M 25/0227; F02M 25/0222; F02M 25/03; F02M 25/028; F02B 2275/32; F01N 3/10; F02M 25/0224; F02M 26/35; F02M 23/12

(57) ABSTRACT

An I.C. engine (and vehicles incorporating the same) connected with an air reservoir and having means of introducing water (or other evaporable fluid). The air reservoir can be used to store energy (in the form of compressed air) while braking the engine and/or allow compressed air to power the engine or to improve its performance. The evaporable fluid can be used: to increase engine efficiency, to increase power, for cooling, as a knock inhibitor, to allow an increased compression ratio, for NOx reduction, to effect other emissions, to aid in controlling HCCI, etc. The cooling effect of evaporable fluid is complementary to storing energy pneumatically since cooler air can be stored more efficiently. Other advantages are also discussed. This engine disclosure further contemplates means to recapture evaporable fluid for reuse (unburned hydrocarbons etc. may also be captured similarly).

### CROSS-REFERENCE TO RELATED APPLICATIONS

Not Applicable

### FEDERALLY SPONSORED RESEARCH

Not Applicable

### SEQUENCE LISTING OR PROGRAM

Not Applicable

### BACKGROUND—FIELD

This application relates to internal combustion engines having pneumatic hybrid capability and also to those having water introduction capability.

### Glossary

For purposes of clarity in the present disclosure the following definitions are given:

Atkinson (or Miller) cycle—both of these refer to cycles where the power stroke is longer than the compression stroke.

BDC—bottom dead center, (this term is typically used for engines with cylinders and is used by the author for illustrative purposes, but is not intended to limit the present invention to engines comprising cylinders).

Evaporable Fluid—fluid which can be changed from a liquid to a gas or from a gas to a liquid.

Heat Exchanger—device for transfer of heat between one or more fluids.

IC Engine—Internal Combustion Engine.

Knock—engine noise due to irregular or rapid combustion.

NOx—molecules having one nitrogen atom and at least one oxygen atom.

Pneumatic Hybrid Engine—an engine capable of storing energy as compressed air—and/or—capable of using compressed air to power the engine (or to enhance engine performance).

Split-Cycle Engine—an engine where the conventional four strokes of the Otto cycle (intake, compression, power and exhaust) are split over two cylinders, one cylinder dedicated to the high pressure compression stroke and the other cylinder dedicated to the high pressure power stroke.

TDC—top dead center, (this term is typically used for engines with cylinders and is used by the author for illustrative purposes, but is not intended to limit the present invention to engines comprising cylinders).

Unburned Hydrocarbons—substances capable of burning which have not been fully burned.

### BACKGROUND—PRIOR ART

Innovators of the internal combustion engine have long sought to improve the efficiency, power, emissions and other qualities of the engine, all the while keeping it affordable. Two effective technologies for accomplishing this include the pneumatic hybrid (also referred to as air hybrid) and water injection. Note that: while the author uses the word water—any evaporable fluid which accomplishes the desired results is considered to be included in this disclosure, including mixtures of water and combustible substance(s), be it/they in liquid, gaseous or aerosol form.

The internal combustion engine may be considered an air pump since it draws air from one location and expels it to another location. Pneumatic hybrid engines can store energy by compressing air—and/or—can use compressed air to power the engine (or to enhance engine performance). This is typically accomplished through valves or ports connected to cylinder(s) and/or to the intake/exhaust manifolds. Pneumatic hybrid engines (and vehicles) are typically more efficient because energy that would normally be lost during slowing of the engine (or braking the vehicle) is captured for later use. Innovators have invented many ways to create such engines, examples include the following:

U.S. Pat. Nos.
U.S. Pat. No. 4,429,532—Jakuba
U.S. Pat. No. 5,315,974—Sabelstrom, et al.
U.S. Pat. No. 5,515,675—Bindschatel
U.S. Pat. No. 6,223,846—Schechter
U.S. Pat. No. 7,464,675—Schechter
U.S. Pat. No. 7,603,970—Scuderi, et al.
U.S. Pat. No. 7,789,181—Schechter
U.S. Pat. No. 7,954,462—Scuderi, et al.
U.S. Pat. No. 8,657,044—Donitz, et al
U.S. Pat. No. 8,800,510—Carlson, et al.
U.S. Pat. No. 9,133,758 B2—Meldolesi, et al.

### US Patent Applications:

20060207257A1—Turner, et al.
20070157894—Scuderi, et al.
20100282225—Gilbert; Ian P.; et al.
   World Pat. No
WO2016060605 (A1)—Hoglund et al.

These various pneumatic (or air) hybrid engine patents do not utilize the potential benefits of introducing water (or other evaporable fluid) into the engine.

Water can be introduced in cylinder, at the air intake, upstream of the intake, mixed with the fuel or by any other suitable means. It has been shown that water can be very useful to improving performance of the internal combustion engine. Water can be used: for cooling, as a knock or detonation inhibitor, to allow an increased compression ratio, for NOx reduction and/or to effect other emissions, to increase efficiency, to increase power and to aid in controlling HCCI, etc. Examples of inventions where water (or evaporable fluid) was used to improve engines include:

U.S. Pat. Nos.:
U.S. Pat. No. 1,261,779—Dempsey
U.S. Pat. No. 1,582,241—Bolton
U.S. Pat. No. 1,555,991—Konar
U.S. Pat. No. 2,352,267—Kelsey
U.S. Pat. No. 2,777,430—Siegfried
U.S. Pat. No. 3,672,341—Smith, et al.
U.S. Pat. No. 4,177,772—Franke
U.S. Pat. No. 4,408,573—Schlueter, et al.
U.S. Pat. No. 5,125,366—Hobbs
U.S. Pat. No. 5,174,247—Tosa, et al.
U.S. Pat. No. 5,400,746—Susa, et al.
U.S. Pat. No. 5,582,155—Knopp
U.S. Pat. No. 7,040,088—Covit
U.S. Pat. No. 7,370,609—Kamio
U.S. Pat. No. 7,819,092—Maul

### US Patent Applications:

20080097679 A1—Keays
20120037100—McAlister, et al.
20110138793 A1—Coletta
20130291826 A1—McAlister
20140366507 A1—Simescu, et al.
   World Pat. Nos.:
WO1996008641 A1—Binion
WO1998003779 A3—Zemer
WO2002048522A1—Simescu, et al.
WO2009155914A1—Wirz
WO2010036097A1—Osman

While these disclosures present many ways for introducing water (or evaporable fluid) into the engine and associated benefits, they do not have the benefit of a pneumatic hybrid system.

US Patent Application 20080202454 A1 to Pirault, does have water introduction and potential for a type of pneumatic hybrid, however it limits itself specifically to only “split-cycle” engines (where intake and compression strokes occur in a separate cylinder from the power and exhaust strokes). The present disclosure excludes “split-cycle” engines. Pirault's invention, though clever, also lacks a potential method of collecting (or re-collecting) water for use in its water injection.

### Advantages of the Present Invention Disclosure

A typical I.C. engine is cooled by fins or by coolant, which add manufacturing cost and essentially waste heat energy. Various complicated ways have been invented to capture that energy, but water introduction provides a relatively simple way to cool the engine (and potentially reduce or eliminate other cooling), while also using that otherwise wasted heat energy to increasing the power and efficiency of the engine.

If water is introduced into a combustion chamber during intake or compression, that water can absorb heat, which in turn lowers the pressure of the combustion chamber (even if the water evaporates). This lower pressure reduces the amount of work required for compression, thus increasing the efficiency and power of the engine. In one embodiment of the present invention the water properties relative to the engine properties are tuned such that the water is evaporated by approximately TDC after compression.

When water vapor is heated it expands more than air. Hence, water vapor present during combustion will increase the pressure in the combustion chamber, more so than regular air without added water vapor. This increased pressure during the power stroke increases the torque, power and efficiency of the engine. The water could be heated or cooled to enable the most optimal results.

The cooling effect of water also allows engines to go to a higher compression ratio. Higher compression ratios give greater efficiency and greater power. But the higher the compression ratio the greater the increase in temperature due to compression. This increased temperature can lead to pre-ignition of the fuel, i.e. the fuel begins burning earlier than intended, which can cause excessive noise (knock) and/or damage to the engine. So the potential for pre-ignition limits the compression ratio an engine can have (this particularly for a spark ignition engine). The cooling effect of water can prevent pre-ignition (and related problems), thus allowing a higher compression ratio in the engine, which in turn increases the power and efficiency of the engine. Water may also be useful in affecting the combustion or reducing noise in compression ignition engines.

Temperature due to compression and combustion can also be a limiting factor, for both spark ignited, compression ignited (and otherwise ignited) engines. This because the engine parts will soften, bend, melt or otherwise wear at high temperatures. So the cooling effect of water can be employed to allow engines to be pushed to greater limits or for materials of lower melting point to be used in manufacturing their components.

NOx emissions are also reduced by water. NOx formation increases with temperature and more rapidly at temperatures above 1,800 K (2780 F). The cooling effect of water can be very effective at reducing the temperatures in the engine, thus less energy is available to break up the triple N—N bond, which is the first step in NO formation via the Zeldovich or thermal mechanism. The Zeldovich mechanism is not the only mechanism for NO formation, but it is a major contributor and it is the mechanism most affected by temperature. Water has the most effect on NOx when the engine is running in a lean (more air than needed to burn all fuel) condition. This reduction in NOx emitted from the engine could allow some aftertreatment components to be made smaller or eliminated, especially the SCR of diesel engines. Fewer (or smaller) aftertreatment components can decrease back pressure on the engine and thus increase engine efficiency and power.

Some might argue that water in the engine would cause corrosion or other problems. However, we should remember that water is a product of combustion (of any fuel containing hydrogen). Consider the combustion of methane for example:

CH₄+2O₂=>2H₂O+1CO₂

Water is always present in engines burning fuel containing hydrogen such as gasoline, natural gas, ethanol, diesel, bio-diesel etc. While additional water may need to be a design consideration when designing an engine, it is not a prohibitive barrier.

To have water to introduce into the engine, water must be available. A water tank could be provided. It some cases this may be a feasible option. But if freezing, refilling, the weight of the water tank etc. are concerns, then water could be collected near the engine. Since water is being introduced into the engine and since water is also a product of combustion it could easily be captured for re-use. It is common to see a bit of water spill out of engine tailpipes, this is from water collecting in the exhaust. This water could be reused. Additionally, if needed, the exhaust could be passed through a heat exchanger for greater cooling and re-collecting of water. A filter or other purification device could also be provided as necessary. Another benefit of recollecting water from the exhaust is that unburned hydrocarbons could be collected also. This would keep this type of pollution from escaping to the environment, and reduce or eliminate the need for a catalytic converter (or other aftertreatment devices), depending on how much of the unburned hydrocarbons can be captured and the emissions regulations where the engine will be sold. These unburned hydrocarbons could be properly disposed of, but to increase efficiency they could also be introduced back into the engine to be more completely burned. Soot and similar emissions could potentially also be captured with the water. This could reduce the need for (or size of) aftertreatment device(s), which in turn would decrease back pressure on the engine and increase efficiency and power. However, if still needed, emissions aftertreatment device(s) may also be employed, such as catalytic converter, diesel oxidation catalyst, diesel particulate filter, selective catalytic reduction and/or ammonia oxidation catalyst.

Humidity in the air could also be collected for water injection. This could be accomplished with a cooling device, such as an air conditioning unit (which often drip condensate water while operating).

The potential for water to freeze, expand and damage the water lines is a concern that can fairly simply be overcome. While the engine is running its heat (or the heat of the exhaust) could be used to keep the water lines from freezing. While the engine is off, if freezing temperatures are of concern for the water lines of the water collection system, then the water could be ejected. Since water can be collected again when the engine starts again, it is not a problem for no water to be on board. Alternatively, the water could be dumped to a small water reservoir created such that freezing water will not damage it. Once the engine starts and the frozen water melts it could be used again.

In addition to all the benefits of water introduction, it is a complementary technology for the pneumatic hybrid. Pneumatic hybrids can be made such that they compress air to simultaneously slow the engine (and vehicle) and store energy. Compression of air creates heat, the hotter the air the less of it that can be stored. If the air being compressed is also heated by the hot engine it will not be stored as efficiently. So keeping the engine cooler complements the pneumatic hybrid. Additionally, water could conceivably be introduced also when air is being compressed into the air reservoir. This could lead to condensation in the air reservoir which may need to be drained, but could potentially be used as a high pressure source for injecting the water. Other means could also be employed to transfer heat to or from the air moving to/from the air reservoir, to obtain desired results.

One embodiment of the pneumatic hybrid engine could be configured with three valves (or three sets of valves), controlled electronically and/or pneumatically and/or hydraulically and/or mechanically etc. such that each valve's operation may be turned on and off (additional variability could allow for further tuning and optimization). One valve for intake, one for exhaust and one for transferring air to/from the air reservoir. During normal operation, the intake and exhaust valves could be opened and closed as typical (intake valve open for intake stroke, exhaust valve open during exhaust stroke). When slowing of the engine (or vehicle) is desired, the intake valve can open for intake and then the air reservoir valve can be opened to allow the engine to compress the air into the air reservoir. The power and exhaust strokes could be skipped, leaving only intake and compression this would increase the engine's ability to brake or slow.

When additional power is desired, the air reservoir valve can be opened instead of the intake valve during intake. This allows the pressurized air to push the piston down (increasing engine power) while filling the cylinder with fresh air. Normally the intake stroke takes power from the engine (in the form of pumping losses), but in this mode of operation the intake stroke increases power. Furthermore, the engine could be operated in a two stroke mode, where right after exhaust gas is released the combustion chamber is filled with pressurized air, fuel is injected and the spark (or other heat) ignites the charge. Thus the intake and compression strokes are skipped, and the engine has a power stroke every revolution. Ideally the valve timing would be optimized for efficiency, power etc.

To increase efficiency, the power stroke could be longer than the compression stroke. This can be accomplished by closing the intake valve before it reaches bottom dead center so that the amount of air in the cylinder is reduced, this effectively reduces the compression stroke. This is also refereed to as Atkinson or Miller cycling.

Additionally, means could be provided to exchange heat with the air passing to or from the air reservoir. One example benefit of this is to cool the air so that more air can be stored.

As desired the air reservoir could have means of being filled by an external source, such as an air compressor. This could save fuel as the engine could run on compressed air for a time.

### DRAWINGS—FIGURES

FIG. 1 shows an internal combustion engine with means to communicate with an air reservoir and means for introducing water, in accordance with one embodiment.

FIG. 2 shows an internal combustion engine with means to communicate with an air reservoir, means for introducing water, a computer, a turbocharger, and means for recollecting water from the exhaust for re-introduction, in accordance with a second embodiment.

FIG. 3 shows an internal combustion engine with means to communicate with an air reservoir, means for introducing water, a computer, a turbocharger, and means for recollecting water from the ambient for introduction, in accordance with a third embodiment.

FIG. 4 shows the pneumatic hybrid I.C. engine, with means of introducing evaporable fluid, in a vehicle.

### DRAWINGS—REFERENCE NUMERALS

10—internal combustion engine
12—cylinder
14—piston
16—cylinder head
18—combustion chamber
20—water injector
22—intake valve
24—intake manifold
26—fuel injector
28—valve to open/close fluid communication with air reservoir
30—air passage to air reservoir, could also contain means for exchanging heat to/from the air passing through it.
32—air reservoir
33—valve (or similar means) permitting the air reservoir to be filled by an external source
34—for spark ignition engines this can represent a spark plug, for compression ignition engines this can represent a glow plug, it could also represent other means for igniting the charge or be omitted.
36—exhaust valve
38—exhaust manifold
42—heat exchanger
43—A.C. unit
44—filter
46—pump
47—device for heating or cooling evaporable fluid
48—computer
50—turbocharger
52—aftertreatment
54—Vehicle

### DETAILED DESCRIPTION

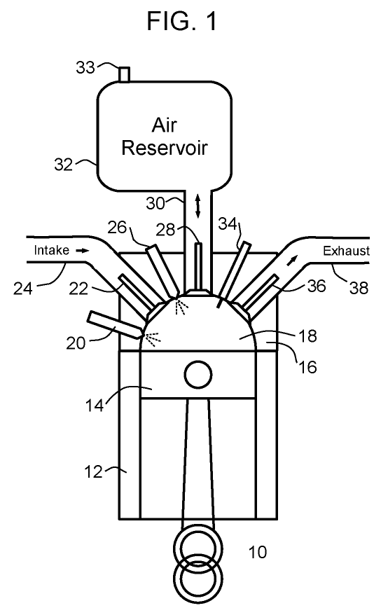

### FIG. 1—First Embodiment

One embodiment of this disclosure is illustrated in FIG. 1. In this embodiment the base engine 10 has a cylinder 12, a piston 14, and a cylinder head 16. These are for illustration and explanation, but are not intended to limit the present disclosure to engines having cylinders and pistons. The combustion chamber 18 is also shown.

Normal Operation:

During normal operation intake valve 22 is opened as the piston 14 moves down for the intake stroke. During the intake stroke, or shortly thereafter, water is introduced from water injector 20. Water may be introduced as a mist to allow it to mix with the intake air. Water may be introduced at multiple times if doing so gives most desirable results. Fuel may be introduced from fuel injector 26 during intake, compression and/or power stroke as is appropriate for the fuel being used. During compression all valves are closed. The amount of water introduced can be tuned such that all of the water will be evaporated by approximately TDC. This allows for cooling of the charge during the full compression stroke, since the water absorbs heat as it evaporates. The additional mass of the water vapor effectively increases the compression ratio of the engine. Increased compression ratio leads to increased efficiency and power density. The charge is ignited at approximately TDC. As the fuel burns it heats the charge. Water vapor expands more than air when heated, increasing the pressure for pushing the piston 14 down for the power stroke. The peak temperature is lower due to the injected water which reduces the amount of NOx formed. The engine also enjoys the other benefits of water introduction as previously mentioned in this disclosure. At approximately BDC the exhaust valve 38 is opened and the piston 14 moves up for the exhaust stroke.

Braking and Storing Energy:

When braking of the engine, or vehicle, is desired the engine can store energy in the air reservoir. The intake valve 22 opens as the piston 14 moves down drawing air in, at approximately BDC the intake valve closes. The piston 14 begins to compress the fresh air. When the pressure in the cylinder 12 and the pressure in the air reservoir 32 are approximately equal, the air reservoir valve 28 opens. Air is compressed into the air reservoir 32, providing braking while storing energy pneumatically.

Stored energy can be used later to power the engine.

Straight pneumatic mode:

At about TDC the air reservoir valve 28 is opened (with other valves closed) allowing high pressure air to push the piston 14 down, powering the engine. The air reservoir valve 36 may be closed immediately to conserve pressurized air, or it may be held open for a time to increase power output. At or before about BDC the air reservoir valve 28 should be closed. At about BCD the exhaust valve 36 is opened, the piston 14 moves up exhausting the air. Then the cycle repeats.

Valve 33 allows for the air reservoir 32 to be filled by external means, such as an air compressor. This can save fuel as the engine could run on compressed air for a time.

Pneumatic 4 Cycle Mode:

At about TDC the air reservoir valve 28 is opened (with other valves closed) allowing high pressure air to push the piston 14 down. At about BDC, water is introduced via injector 20. Fuel is introduced via injector 26 when appropriate depending on the fuel. The piston 14 moves up compressing the charge and evaporating the water (as in normal operation). The fuel burns increasing temperature of the charge and driving the piston 14 down for power stroke. At about BDC the exhaust valve 38 is opened for the exhaust stroke. Then the cycle repeats.

Pneumatic 2 Cycle Mode:

At approximately TDC the air reservoir valve 28 is opened allowing pressurized air into the combustion chamber, shortly thereafter this valve is closed. Fuel is injected. Water may also be injected as desired. The charge is ignited and the pressure increases. High pressure pushes the piston 14 down for the power stroke. At about BDC the exhaust valve 36 opens, the piston 14 moves up exhaling the exhaust. Then the cycle begins again immediately.

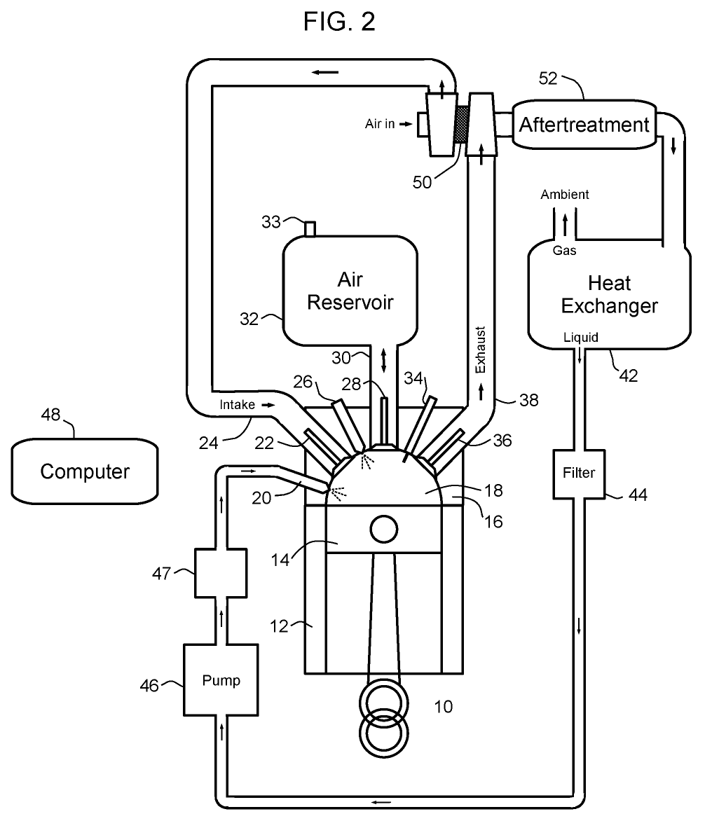

### FIG. 2—Second Embodiment

The second embodiment has all the components and potential modes as the first embodiment and also shows additional components. Computer 48 may be used to control the engine. It may read in information from the engine. It may be used to control and/or optimize: valve timing, fuel injection timing and amount, and water injection timing and amount. The computer could use feedback from the engine to optimize its controls. The computer could also be used for many other things that could come to mind by someone with ordinary skill in the art.

Turbocharger 50 allows energy in the exhaust to be used to increase air flow into the engine, which can increase power and/or efficiency. Aftertreatment 52 is to assist in reducing emissions. It could comprise but is not limited to, any one or combination of the following: catalytic converter, diesel oxidation catalyst, diesel particulate filter, selective catalytic reduction and/or ammonia oxidation catalyst.

Heat exchanger 42 is used to separate the water from the exhaust gases to be used for re-introduction into the engine. As the exhaust gases are cooled the water condenses and can be separated. This heat exchanger could also be used to collect other liquids, such as hydrocarbons. It could also be used to collect solid particles such as soot, which could be burned in the engine or disposed of. Filter 44 may be used to clean the water before it is re-introduced into the engine. The filter could be cleaned or disposed of. Pump 46 can be used to assist in the flow of water, and/or to increase the pressure of water, for introduction into the engine. Device 47 is for altering the temperature of the evaporable fluid as may be desirable to give best results. Device 47 could be a heat exchanger, heater, refrigeration unit or any suitable device able to heat and or cool the evaporable fluid.

Air passage 30 could also contain means for exchanging heat to/from the air passing through it. One example of this could be a heat exchanger to cool the air going into the air reservoir to allow more air to be stored in it. Another example could be a mesh which could hold heat as the air is compressed into the air reservoir, then return heat to the air when it is returned to the combustion chamber.

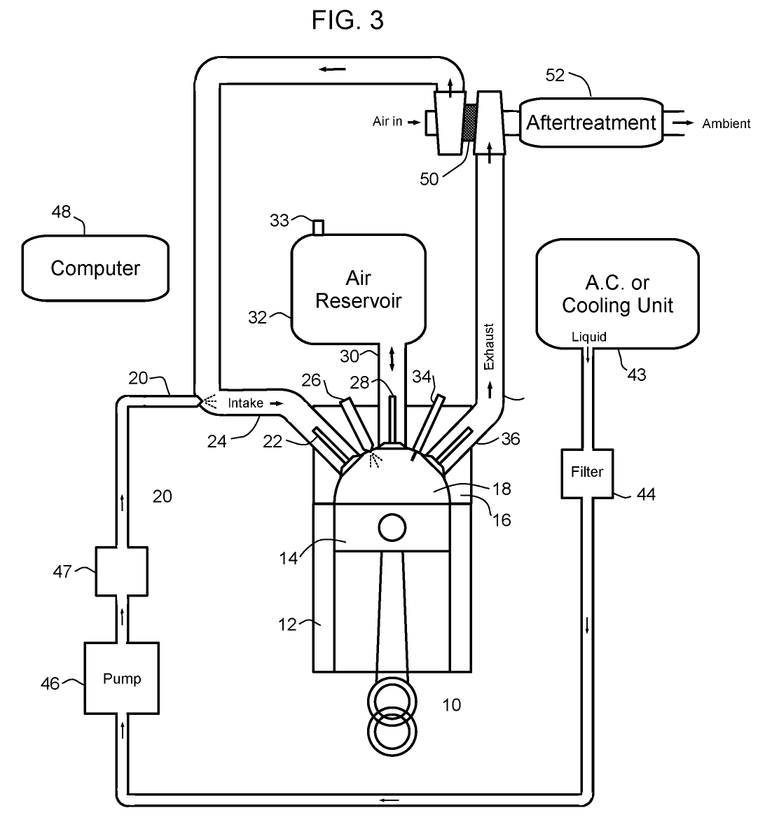

### FIG. 3—Third Embodiment

The third embodiment has similar functions and modes of operation as the first and second embodiments. But the third embodiment shows means of collecting evaporable fluid from the ambient, in this case an A.C. unit 43. Water often collects on A.C. units because they are cooler then the surrounding air. Thus they could also serve as a means of collecting water for injection into the engine. This embodiment also shows water injector 20 in an alternative location, allowing the evaporable fluid to be introduced in the intake manifold.

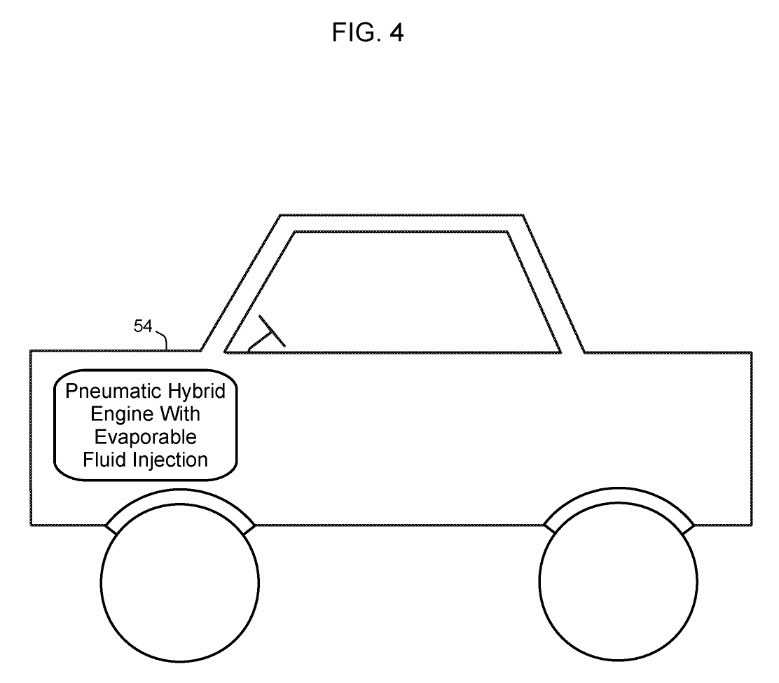

### FIG. 4—Forth Embodiment

The fourth embodiment shows a vehicle 54 with, the pneumatic hybrid I.C. engine with means of introducing evaporable fluid.

1. A pneumatic hybrid internal combustion engine with means of introducing evaporable fluid into said engine, comprising:
(a) an internal combustion engine, excluding split-cycle type engines, with means of air intake, compression, power extraction, and exhaust,
(b) at least one combustion chamber,
(c) at least one air reservoir, with means of fluid communication to the engine,
(d) means for opening and closing fluid communication between engine and air reservoir, to allow air flow between the air reservoir and the engine,
(e) means for introducing evaporable fluid, such as but not limited to water, into engine.

2. The engine of claim 1 further comprising electronic means, such as a computer, for controlling said engine.

3. The engine of claim 1 wherein the evaporable fluid is introduced directly into the combustion chamber.

4. The engine of claim 1 wherein the evaporable fluid is introduced via the intake manifold.

5. The engine of claim 1 further comprising means for altering the temperature of the evaporable fluid before introduction.

6. The engine of claim 1 further comprising a forced induction device, such as a turbocharger.

7. The engine of claim 1 wherein the power stroke is longer than the compression stroke, such as Atkinson or Miller cycle.

8. The engine of claim 1 further comprising means for the air reservoir to receive air from an alternate source, such as but not limited to, an air compressor.

9. The engine of claim 1 further comprising means to alter the temperature of the air which moves through the air passage between the air reservoir and the engine.

10. The engine of claim 1 further comprising an emissions aftertreatment, such as but not limited to, catalytic converter, diesel oxidation catalyst, diesel particulate filter, selective catalytic reduction and/or ammonia oxidation catalyst.

11. The engine of claim 1 further comprising means for purifying the evaporable fluid, such as a filter.

12. The engine of claim 1 further comprising means of collecting evaporable fluid for said introduction into the engine.

13. The engine of claim 12 further comprising means whereby the evaporable fluid is collected from the ambient, such as condensate from an air conditioning unit.

14. The engine of claim 12 further comprising means whereby the evaporable fluid is collected from the exhaust, such as but not limited to, cooling the exhaust through a heat exchanger to condense fluid out.

15. The engine of claim 12 further comprising means for collecting unburned hydrocarbons from the exhaust.

16. The engine of claim 12 further comprising means for collecting soot from the exhaust.

17. The engine of claim 12 further comprising means for introducing unburned hydrocarbons and/or soot into the combustion chamber.

18. The engine of claim 1 further comprising a vehicle.
